(19) United States
(12) Patent Application Publication
(10) Pub. No.: US 2008/0308710 A1
(43) Pub. Date: Dec. 18, 2008

(54) Mold with a returning apparatus

(76) Inventors: Chen-Chih Yu, Tu-Cheng City (TW); Jian-Ren Wang, Tu-Cheng City (TW); Guo-Bing Xu, Tu-Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/808,937

(22) Filed: Jun. 14, 2007

(51) Int. Cl. B29C 33/44

(52) U.S. Cl. 249/68

(57) ABSTRACT

A mold with a returning apparatus includes a female and a male mold. The male mold has a fix plate with a through bore, a lower eject plate, an upper eject plate, an eject pin fixed to the upper eject plate, and a returning apparatus. The returning apparatus has a pull rod and a returning portion having a gap. The pull rod defines a top at one end thereof, a surrounding portion adjacent to the top, and a compression formed between the top and the surrounding portion. The gap has a first cavity at an upper portion thereof, a second cavity communicating with the first cavity at a lower portion thereof, and a step formed therebetween. The size of the first cavity is bigger than the second cavity. The top is received in the first cavity, the surrounding portion is received in the second cavity, and the compression abuts against the step.

### BACKGROUND OF THE INVENTION

1. Field of the Invention

The present invention generally relates to a mold, and more particularly to a returning apparatus for returning a set of eject plates to their original positions.

2. The Related Art

A conventional mold with a returning apparatus is shown in FIG. 1. The mold comprises a female mold 62 with an eject block 621 that is fixed on one side of the female mold 62 and a male mold 1′ which includes an oscillating block 611, an upper eject plate 612 connecting with the oscillating block 611, a lower eject plate 613 and a locating ring 614. When the mold opens, the upper eject plate 612 moves upward and drives an angular eject pin to push a molded article out. The oscillating block 611 pivots clockwise a certain degree by a stress with which the upper eject plate 612 provides. When the mold clamps, the locating ring 614 guides the eject block 621 to abut against the oscillating block 611 and the oscillating block 611 pivots counterclockwise. Also the upper eject plate 612 moves downward with a stress with which the oscillating block 611 provides. The angular eject pin moves downward to its original position following the trace of the upper eject plate 612.

Although the conventional mold returns the eject plates 612, 613 to their initial positions, more components of the returning apparatus are too many to make sure the mold work effectively. Thus, it would be desirable to provide a new returning apparatus that overcomes the problem encountered with previously returning apparatus.

### SUMMARY OF THE INVENTION

An object of the present invention is to provide a mold with a returning apparatus being of simple design and low cost. The mold comprises a female mold and a male mold. The male mold has a fix plate with a through bore defined therethrough, a lower eject plate located above the fix plate, an upper eject plate connecting with the lower eject plate, an eject pin fixed to the upper eject plate and a returning apparatus. The returning apparatus has a pull rod and a returning portion. The pull rod defines a circular groove at a portion near to one end thereof to form a surrounding portion, a top formed as a chapiter at the end of the pull rod, and a compression formed between the top and the surrounding portion. The returning portion received in the through bore has a gap. The gap has a first cavity communicating with the outside at an upper portion thereof, a second cavity communicating with the first cavity and the outside at a lower portion thereof and a step formed therebetween. The size of the first cavity is bigger than the second cavity. The top of the pull rod is received in the first cavity, the surrounding portion of the pull rod is received in the second cavity, the compression abuts against the step, the pull rod passes through the through bore for receiving an external force.

As described above, the eject plates move upward or downward to push a molded article out or return the angular eject pin to its original position. The design of the returning apparatus can be provided to work effectively with a simple frame and a low cost.

### BRIEF DESCRIPTION OF THE DRAWINGS

The present invention will be apparent to those skilled in the art by reading the following description of a preferred embodiment thereof, with reference to the attached drawings, in which:

FIG. 1 is a perspective view of a conventional mold;

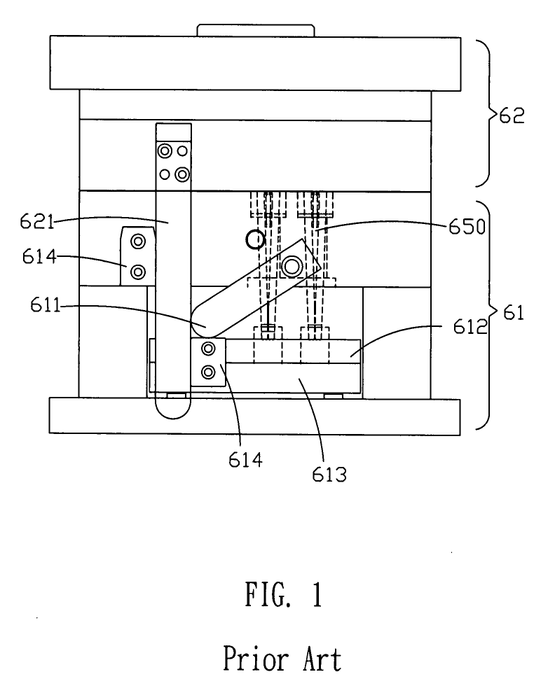

FIG. 2 is a perspective view of a mold with a returning apparatus;

FIG. 3 is an exploded views of the returning apparatus;

FIG. 4 is a perspective view of the mold with a molded article being extracted out;

FIG. 5 is a partial enlarged view of the encircled portion labeled V shown in FIG. 4;

FIG. 6 is a perspective view of the mold, with an angular eject pin in its initial position; and

FIG. 7 is a partial enlarged view of the encircled portion labeled VII shown in FIG. 6.

### DETAILED DESCRIPTION OF THE PREFERRED EMBODIMENT

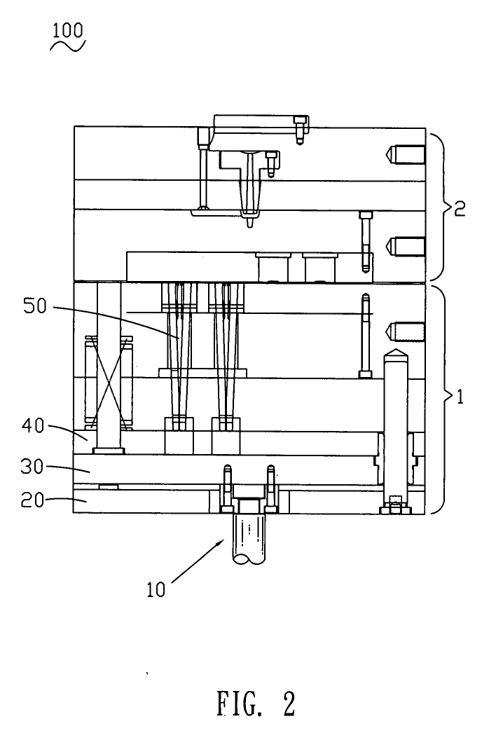

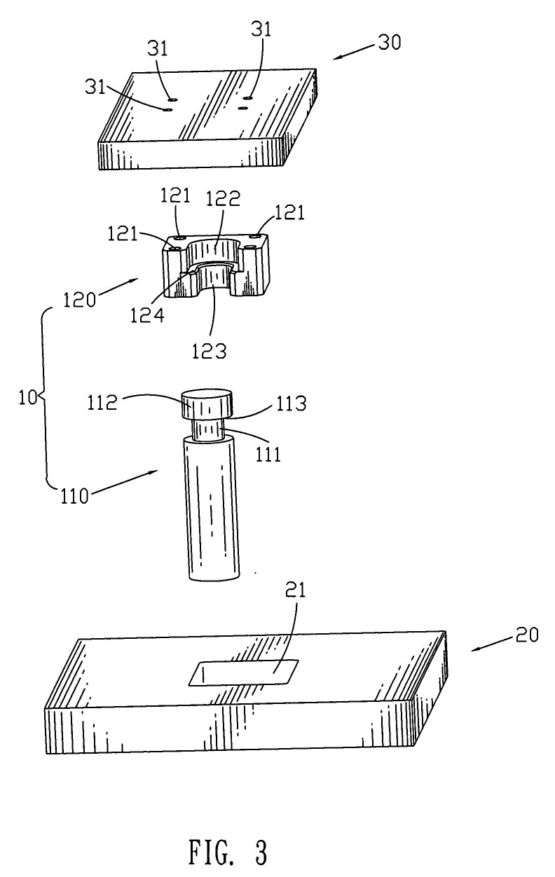

With reference to FIG. 2 and FIG. 3, a mold 100 comprises a female mold 2 and a male mold 1 which includes a fix plate 20 at the bottom, a lower eject plate 30 above the fix plate 20, an upper eject plate 40 connecting with the lower eject plate 30, a returning apparatus 10, an angular eject pin 50 fixed to the upper eject plate 40. The fix plate 20 has a through bore 21 in the middle thereof. The lower eject plate 30 defines multiple symmetrical spiral holes 31 therethrough.

The returning apparatus 10 comprises a pull rod 110 and a returning portion 120 coupled to the pull rod 110. The pull rod 110 defines a circular groove at a portion near to one end thereof to form a surrounding portion 111. The radius of the surrounding portion 111 is smaller than the radius of the pull rod 110. A top 112 is formed as a chapiter at the end of the pull rod 110 and adjacent to the surrounding portion 111. The radius of the top 112 is bigger than the radius of the surrounding portion 111. A compression 113 is formed between the top 112 and the surrounding portion 111. The returning portion 120 has a U-shaped gap. The gap has a first cavity 122 communicating with the outside at an upper portion thereof, and a second cavity 123 communicating with the first cavity 122 and the outside at a lower portion thereof. The size of the first cavity 122 is bigger than the second cavity 123, therefore a step 124 is formed between the first cavity 122 and the second cavity 123. Multiple locating holes 121 are symmetrically defined at the corners of the returning portion 120 and are respectively fastened to the spiral holes 31 with screws so as to fix the returning portion 120 to the bottom of the lower eject plate 30. The pull rod 110 mates with the returning portion 120 with the top 112 received in the first cavity 122, with the surrounding portion 111 received in the second cavity 123, and with the compression 113 abutting against the step 124. The returning portion 120 is received in the through bore 21 of the fix plate 20. The pull rod 110 passes through the through bore 21 to connect with an external device that provides an external force (no shown).

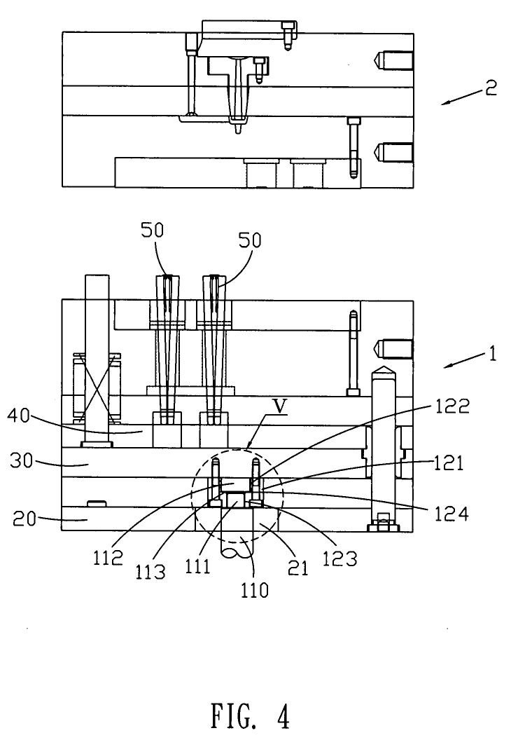

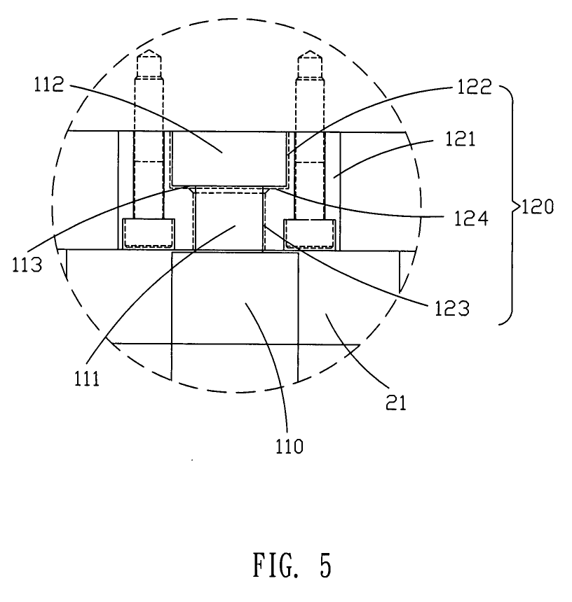

With reference to FIG. 3, FIG. 4 and FIG. 5, when a molded article installed in the mold 100 is finished, the male mold 1 is released from the female mold 2. The pull rod 110 pushes the lower eject plate 30 upward, the returning portion 120 moves upward following the lower eject plate 30 to leave the through bore 21, and the upper eject plate 40 follows the lower eject plate 30 to push the molded article out of the mold 100 with the angular eject pin 50.

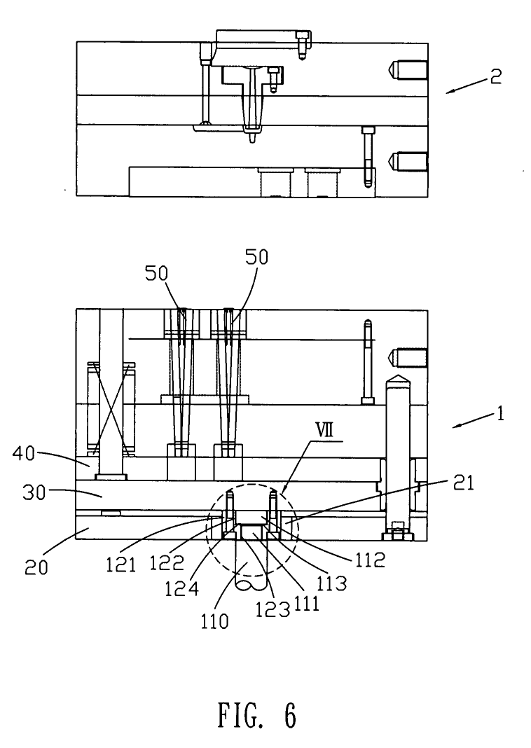

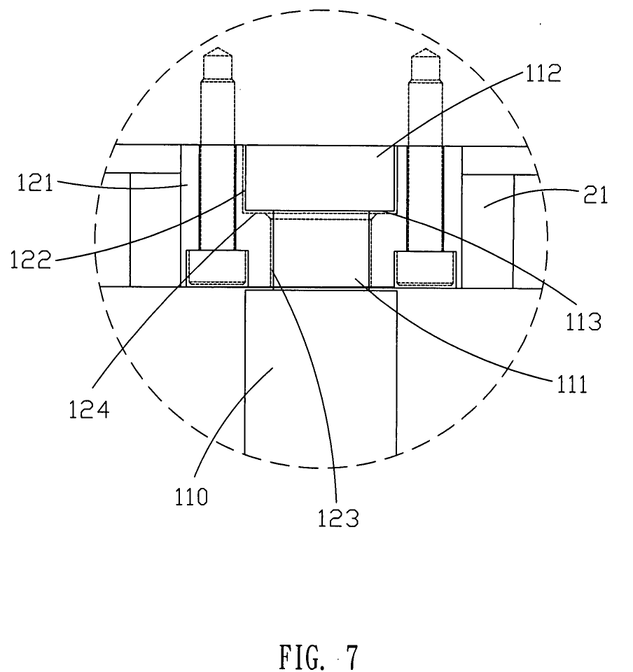

With reference to FIG. 6 and FIG. 7, when the molded article is fetched out, the external force is provided for returning the lower eject plate 30 and the upper eject plate 40 to their original positions. The top 112 abutting against the step 124 moves downward following the external force. The returning portion 120 moves downward into the through bore 21 again. The lower eject plate 30 moves downward to its original position following the trace of the pull rod 110, also the upper eject plate 40 fastened to the lower eject plate 30 moves downward to its original position following the trace of the lower eject plate 30. The angular eject pin 50 fastened to the upper eject plate 40 moves downward to its original position following the trace of the upper eject plate 40.

As described above, the foregoing description of the present invention has been presented for purposes of illustration and description. The returning portion 120 mates with the pull rod 110 with the top 112 of the pull rod 110 abutting against the step 124 of returning portion 120. The eject plates 30, 40 move up or down to push the molded article out or return the angular eject pin 50. The design of the returning apparatus 10 can be provided to work effectively with a simple frame and a low consumption.

What is claimed is:

1. A mold with a returning apparatus comprising a male mold and a female mold, the male mold having:
a fix plate, defining a through bore therethrough;
a lower eject plate, located above the fix plate;
an upper eject plate connecting with the lower eject plate;
an eject pin fixed to the upper eject plate;
a returning apparatus, having:
a pull rod, said pull rod defining a top formed as a chapiter at one end of the pull rod, a surrounding portion being adjacent to the top, a compression being formed between the top and the surrounding portion,
a returning portion received in the through bore, having a gap, the gap having a first cavity communicating with the outside at an upper portion thereof, and a second cavity communicating with the first cavity and the outside at a lower portion thereof, the size of the first cavity being bigger than the second cavity, a step being formed therebetween,
wherein the top of the pull rod is received in the first cavity, the surrounding portion of the pull rod received in the second cavity, the compression abutting against the step, the pull rod passing through the through bore for receiving an external force.

2. The mold with a returning apparatus as claimed in claim 1, wherein the gap of returning portion is U-shaped.

3. The mold with a returning apparatus as claimed in claim 1, wherein the surrounding portion is a circular groove.
